(19) United States
(12) Patent Application Publication
(10) Pub. No.: US 2022/0261616 A1
(43) Pub. Date: Aug. 18, 2022

(54) CLUSTERING-BASED QUANTIZATION FOR NEURAL NETWORK COMPRESSION

(71) Applicant: VID SCALE, INC., Wilmington, DE (US)

(72) Inventors: Duanshun Li, Plainsboro, NJ (US); Dong Tian, Boxborough, MA (US); Hua Yang, Plainsboro, NJ (US); Yuwen He, San Diego, CA (US)

(73) Assignee: VID SCALE, INC., Wilmington, DE (US)

(21) Appl. No.: 17/622,954

(22) PCT Filed: Jul. 1, 2020
(86) PCT No.: PCT/US2020/040409

§ 371 Date: Dec. 27, 2021

Related U.S. Application Data
(60) Provisional application No. 62/869,754, filed on Jul. 2, 2019.

(51) Int. Cl. G06N 3/04

(52) U.S. Cl. CPC G06N 3/04

(57) ABSTRACT

Systems, methods, and instrumentalities are disclosed for clustering-based quantization for neural network (NN) compression. A distribution of weights in weight tensors in NN layers may be analyzed to identify cluster outliers. Cluster inliers may be coded from cluster outliers, for example, using scalar and/or vector quantization. Weight-rearrangement may rearrange weights for higher dimensional weight tensors into lower dimensional matrices. For example, weight rearrangement may flatten a convolutional kernel into a vector. Correlation between kernels may be preserved, for example, by treating a filter or kernels across a channel as a point. A tensor may be split into multiple subspaces, for example, along an input and/or an output channel. Predictive coding may be performed for a current block of weights or weight matrix based on a reshaped or previously coded block or matrix. Arrangement, inlier, outlier, and/or prediction information may be signaled to a decoder for reconstruction of a compressed NN.

### CROSS REFERENCE TO RELATED APPLICATIONS

This application claims priority to U.S. Provisional Patent Application No. 62/869,754, filed on Jul. 2, 2019, the entirety of which is incorporated by reference as if fully set forth herein.

### BACKGROUND

Neural Network Representation (NNR) coding systems may be used to compress neural network models, for example, to reduce the storage and/or transmission bandwidth needed for such models. NNR coding systems may include block-based, wavelet-based, and/or object-based systems.

### SUMMARY

Systems, methods, and instumentalities are disclosed for clustering-based quantization (for example, hierarchical or k-means clustering-based quantization) for neural network (NN) model compression. An NN model may be a type of NN model utilized to process video, audio, medical, speech, etc. An NN model may represent, for example, a data model, a mathematical model including one or more parameters and/or functions, etc. Clustering-based quantization may analyze a tensor arrangement of parameters of NN layer(s) (for example, convolutional NN (CNN) layer(s)) and/or cluster outlier(s).

A device, such as a coding device, may use cluster-based quantization for NN compression and may analyze the distribution of one or more NN weights in weight tensors in NN layers. For example, the device may identify and/or separate outliers outside clusters from inliers within clusters. The device may use identified and/or separated outliers outside clusters from the inliers within clusters to apply clustering-based quantization, such as a K-means clustering based quantization. The device may detect, remove or separate, and/or code (e.g., code separately) cluster outliers in the weight tensors from cluster inliers. Inliers (for example, remaining weights after outlier removal) may be coded (for example, using scalar and/or vector quantization) separately from outliers. The device may detect one or more outlier using one or more outlier detection processes. The device may select the one or more outlier detection processes based on a dimension of the points (for example, one-dimensional points). The device may signal inlier and/or outlier information, for example, to a decoding device, such as a decoder (for example, for reconstruction of a compressed NN model). Weight tensor and weight matrix may be used interchangeably herein.

Cluster-based quantization for NN compression may employ weight-rearrangement, for example, to preserve cross-kernel correlation. Network weights (for example, for higher dimensional weight tensors for CNN layers), may be rearranged into two dimensional matrices. Vector quantization may be performed row-wisely or column-wisely on the rearranged matrices. An arrangement may result in a correlation (for example a large correlation) between the row vectors (or column vectors) in the resultant matrices. For example, a device, such as a coding device, may rearrange a convolutional kernel into a vector, e.g., using weight rearrangement. A single filter or multiple kernels across a channel may be treated as a point. Correlation between kernels may be preserved, for example, by treating one or more kernels across a channel as a point during clustering. A tensor may be split into multiple subspaces, for example, along an input channel. A tensor may be spit into multiple subspaces, for example, along an output channel. The device may perform prediction (for example, for a current block of weights or a current weight matrix) based on a reshaped or a previously coded block of weights or a previously coded weight matrix. The device may signal arrangement information, prediction information, etc., for example, to a decoder (for example, for reconstruction of a compressed NN model).

In examples, methods may be implemented (for example, in a codec) to perform clustering-based quantization or inverse quantization for NN compression or decompression/reconstruction of a compressed NN. The methods may be implemented, for example, by an apparatus. The apparatus may include one or more processors configured to execute computer executable instructions. The one or more computer executable instructions may be stored on a computer readable medium or a computer program product, that, when executed by the one or more processors, performs the method. The apparatus may include one or more processors configured to perform the method. The computer readable medium or the computer program product may include instructions that cause one or more processors to perform the methods by executing the instructions. A computer readable medium may include data content generated according to the methods. A signal may include a codebook and code index, outliers and an outlier index, and/or predictions for a weight matrix or a block of weights in a weight matrix generated based on clustering-based quantization with reshaping, outlier detection and removal, and/or predictive coding for NN compression of an original weight matrix according to the methods described herein.

A method of encoding using clustering-based quantization for NN compression may include, for example, obtaining an NN model including an NN layer that is associated with a weight matrix, such as a weight tensor; identifying a dimensionality of the weight matrix; reshaping the weight matrix to reduce the dimensionality of the weight matrix based on the identified dimensionality of the weight matrix; and coding the NN layer based on the reshaped weight matrix.

Reshaping the weight matrix may include, for example, flattening or rearranging the dimensionality of the weight matrix.

Example dimensionalities of the weight matrix may include, for example, two dimensions (2D), three dimensions (3D), four dimensions (4D), or higher dimensions. The weight matrix may be reshaped, for example, to a one-dimension (1D) weight vector. Dimensionality may be reduced from a multi-dimension to (for example, any) lower dimension (for example, 4D to 3D, 4D to 2D, 3D to 2D, 2D to 1D, 3D to 1D, 4D to 1D, etc.).

An NN layer may include, for example, a convolutional NN (CNN) layer, a fully connected layer, or a bias layer.

The method may further include, for example, transmitting the identified dimensionality and the reduced dimensionality of the weight matrix in a bitstream.

In an example, coding the NN layer may include performing quantization. Quantization may be clustering-based quantization. Outliers may be removed prior to quantizing inliers within a cluster.

Quantization may include, for example, vector quantization.

The method may further include performing prediction (for example, for a current block of weights or a current weight matrix) based on the reshaped or previously coded block of weights or weight matrix.

A method of decoding may include, for example, obtaining a compressed NN model comprising a quantized NN layer that is associated with a weight matrix having a first dimensionality; obtaining a weight matrix shape indication indicating a weight matrix shape having a second dimensionality; reshaping the weight matrix to the second dimensionality based on the weight matrix shape indication; and decoding the NN layer based on the reshaped weight matrix.

Reshaping the weight matrix may include, for example, restoring the weight matrix having the first dimensionality to the weight matrix having the second dimensionality. The weight matrix shape having the second dimensionality may include, for example, the weight matrix having an original dimensionality prior to the quantization. The weight matrix shape indication may indicate, for example, a number of columns and a number of rows associated with the original dimensionality. The second dimensionality of the weight matrix may include, for example, 2D, 3D, 4D, or higher dimensions. The weight matrix may be reshaped, for example, by increasing the first dimensionality of the weight matrix to the second dimensionality of the weight matrix. Dimensionality may be increased from a lower dimension to a higher dimension (for example, 3D to 4D, 2D to 4D, 2D to 3D, 1D to 2D, D to 3D, 1D to 4D, etc.).

In examples, a coding device, such as a neural network model based encoder, a video encoder, etc., may be configured to obtain an NN model having multiple layers; identify, for a convolutional layer of the NN model, a convolutional layer weight tensor (for example, a 4-D tensor, such as K1×K2×Cin×Cout); rearrange the convolutional layer weight tensor, for example, by vectorizing the weight matrix in into a vector (for example, K1×K2→K1K2); and perform vector quantization on the convolutional layer using the rearranged convolutional layer weight tensor (for example, K1K2×Cin×Cout).

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram showing an example video encoder.

FIG. 3 is a diagram showing an example of a video decoder.

FIG. 4 is a diagram showing an example of a system in which various aspects and examples may be implemented.

FIG. 5 illustrates an example of a neural network codec.

FIG. 6 illustrates an example of CNN layers arranged in 3D.

FIG. 7 illustrates an example of clustering-based quantization with outlier removal.

FIG. 8 illustrates an example of inverse quantization.

FIG. 9 illustrates an example tensor rearrangement of two-dimensional weights for vector quantization.

FIGS. 10A-C illustrate an example 1-D convolution tensor arrangement.

FIGS. 11A and 11B illustrate an example K-means clustering without and with outlier removal.

FIGS. 12A and 12B illustrate an example of outlier detection.

FIG. 13 illustrates an example quantization with outlier removal.

FIG. 14 illustrates an example of a method for encoding.

FIG. 15 illustrates an example of a method for decoding.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application.

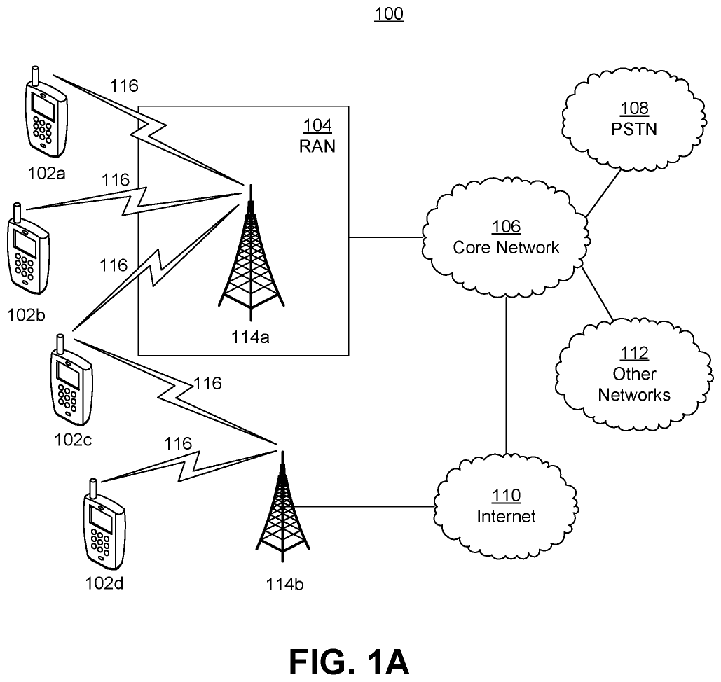

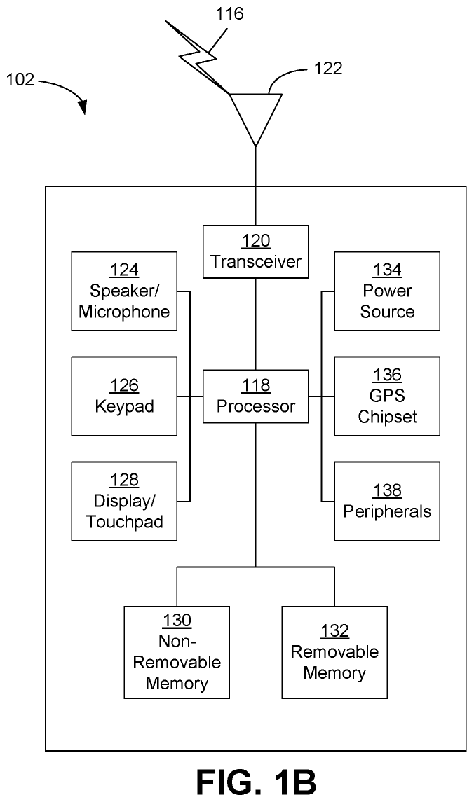

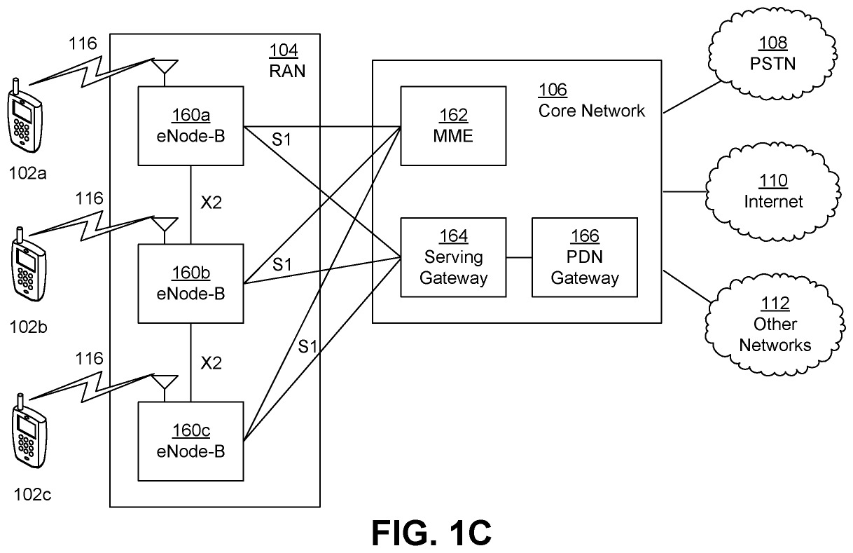

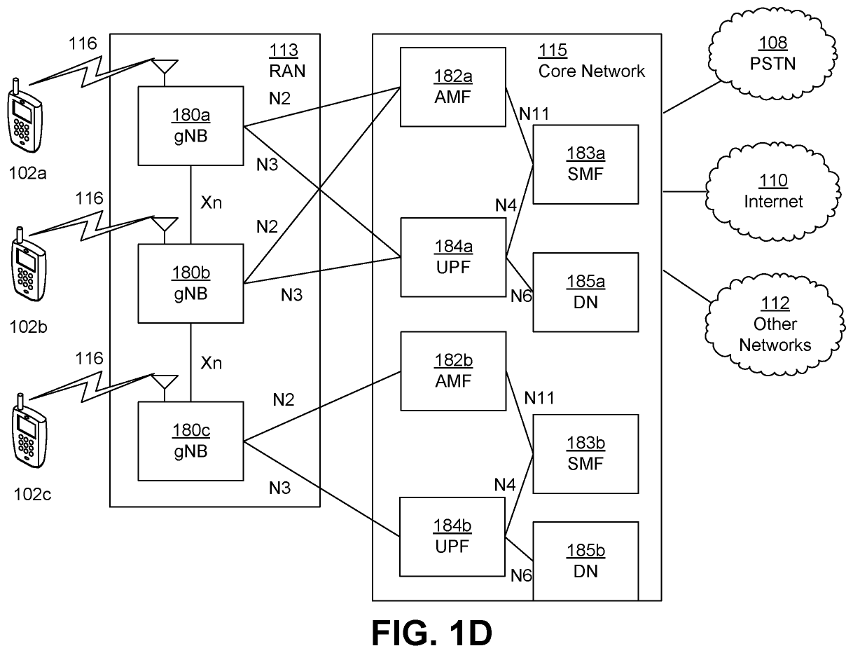

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicanier (FBMC), and the like.

As shown in FIG. 1A, the communications system 100 may include wireless transmit/receive units (WTRUs) 102a, 102b, 102c, 102d, a RAN 104/113, a CN 106/115, a pubic switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station and/or a STA, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or M-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM). Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air conidor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a iquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NM-H), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Realty (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor, a geolocation sensor, an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b. 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an ad-hoc mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 8040 configuration. For the 8040 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery fife).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among al STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b. 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a. 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b, and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment Direct RF coupling and/or wireless communications via RF circuitry (e.g., which may include one or more antennas) may be used by the emulation devices to transmit and/or receive data.

This application describes a variety of aspects, including tools, features, examples or examples, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects may be combined and interchanged to provide further aspects. Moreover, the aspects may be combined and interchanged with aspects described in earlier filings as well.

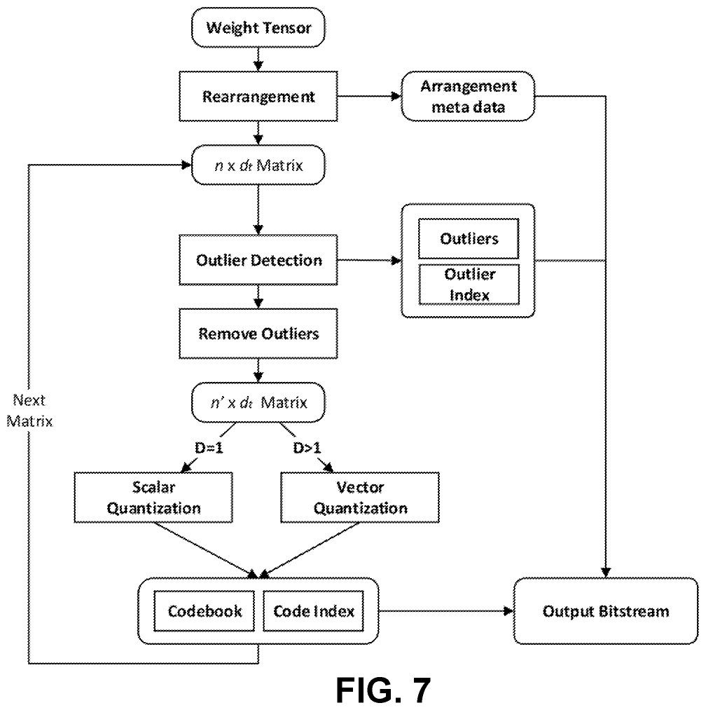

The aspects described and contemplated in this application may be implemented in many different forms. FIGS. 7-15 described herein may provide some examples, but other examples are contemplated. The discussion of FIGS. 7-15 does not limit the breadth of the implementations. At least one of the aspects generally relates to video encoding and decoding, and at least one other aspect generally relates to transmitting a bitstream generated or encoded. These and other aspects may be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms reconstructed and decoded may be used interchangeably, the terms pixel and sample may be used interchangeably, the terms image, picture and frame may be used interchangeably.

Various methods are described herein, and each of the methods may include one or more steps or actions for achieving the described method. Unless a specific order of steps or actions is required for proper operation of the method, the order and/or use of specific steps and/or actions may be modified or combined. Additionally, terms such as first, second, etc. may be used in various examples to modify an element, component, step, operation, etc., such as, for example, a first decoding and a second decoding. Use of such terms does not imply an ordering to the modified operations unless specifically required. So, in this example, the first decoding may not be performed before the second decoding, and may occur, for example, before, during, or in an overlapping time period with the second decoding.

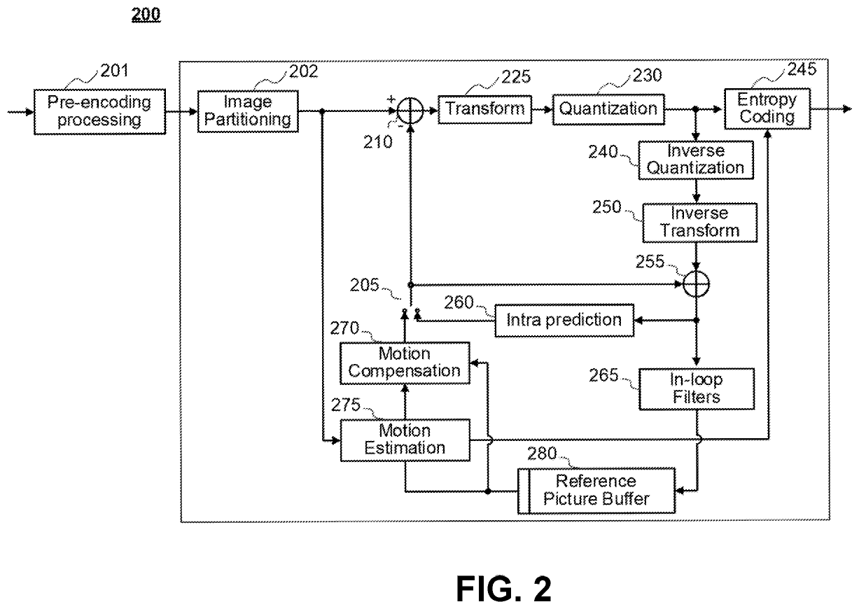

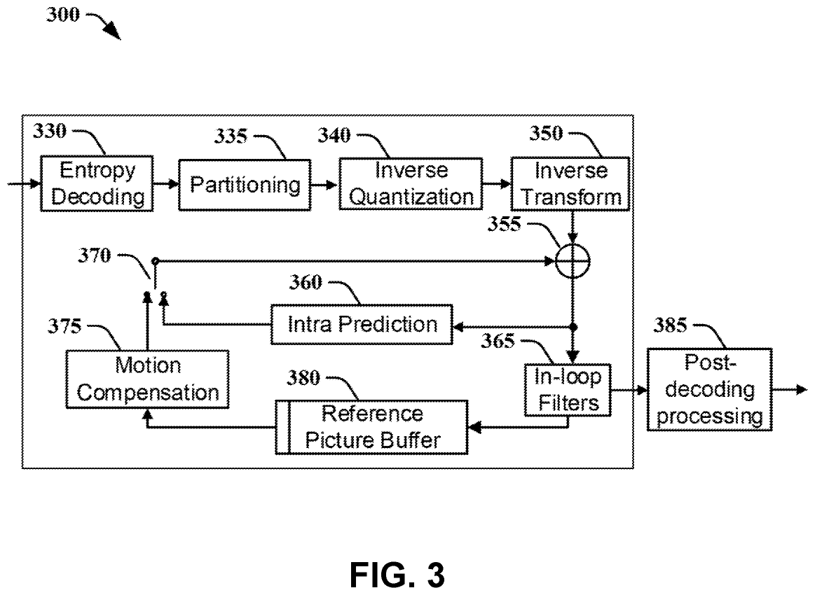

Various methods and other aspects described in this application may be used to modify modules, for example, pre-encoding processing 201, image partitioning 202, quantization 230, entropy coding 245, intra prediction 260, entropy decoding 330, partitioning 335, inverse quantization 340, intra prediction 360 and post-decoding processing 385, of a video encoder 200 and decoder 300 as shown in FIG. 2 and FIG. 3. Moreover, the subject matter disclosed herein presents aspects that are not limited to WC or HEVC, and may be applied, for example, to any type, format or version of video coding, whether described in a standard or a recommendation, whether pre-existing or future-developed, and extensions of any such standards and recommendations (e.g., including WC and HEVC). Unless indicated otherwise, or technically precluded, the aspects described in this application may be used individually or in combination.

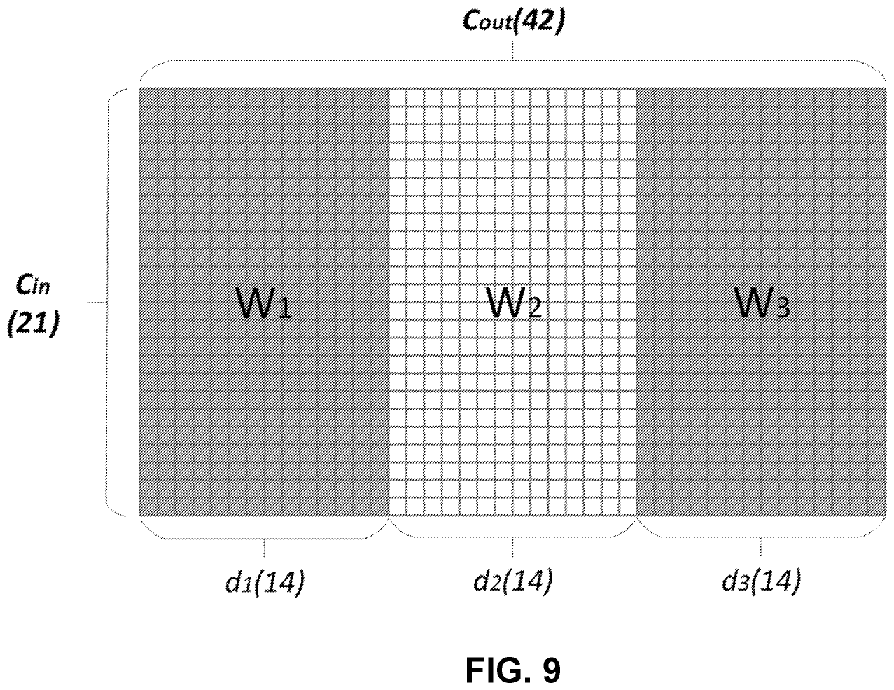

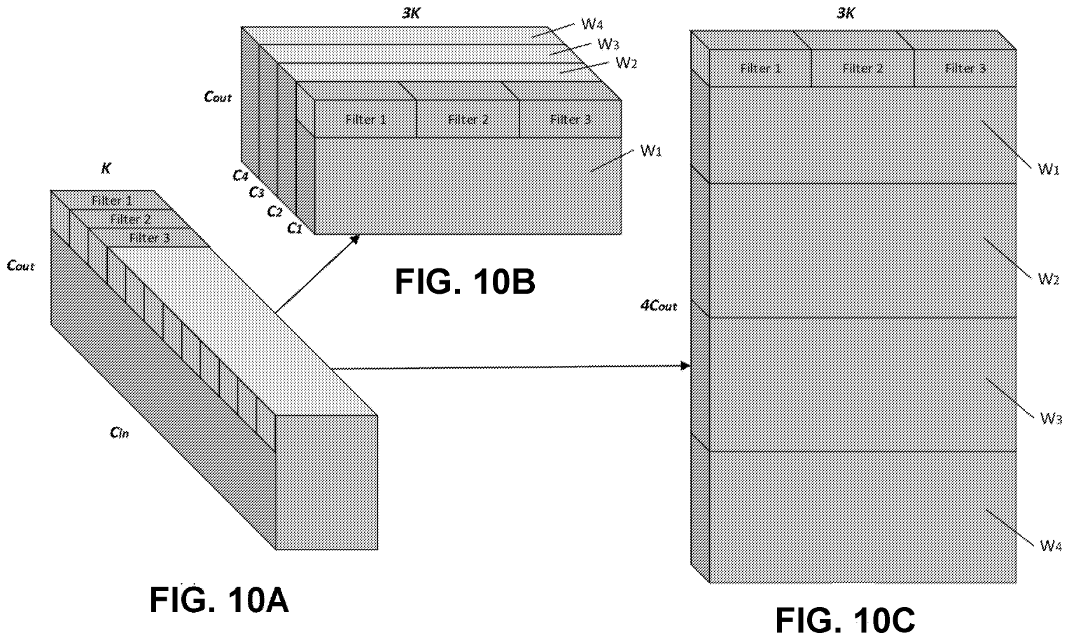

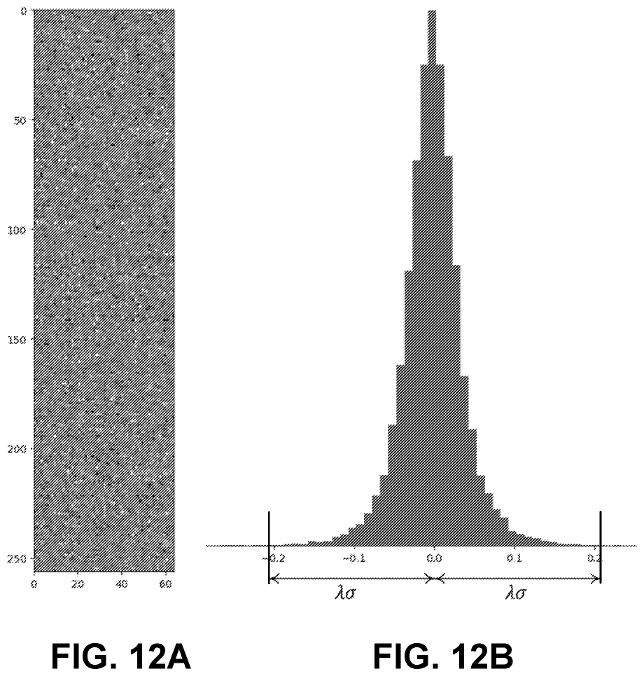

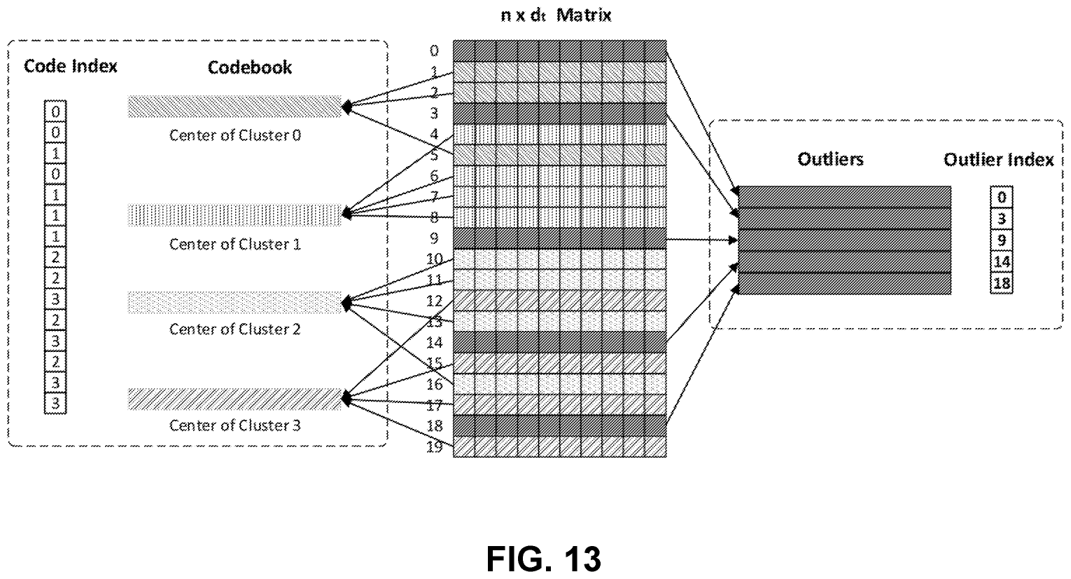

Various numeric values are used in examples described the present application, such as the weight matrix shape, submatrix shapes and concatenated shapes shown in FIG. 9 (for example, shape Cᵢₙ=42 and Cₒᵤₜ=21, conversion into three (3) 21×14 sub-matrices and concatenated into a 63×14 shape), input channels and matrices in FIG. 10 (for example, 12 input channels split into four matrices of shape 3K×Cₒᵤₜ), benchmarking statistics shown in FIG. 12, the matrix, clusters, codebook and outliers shown in FIG. 13 (for example, the 20×10 matrix, clusters 0-3, representation of each index with two bits, codebook of size 4×10, and five outlier row indices index 0, 3, 9, 14, 18)), etc. These and other specific values are for purposes of describing examples and the aspects described are not limited to these specific values.

FIG. 2 is a diagram showing an example video encoder. Variations of example encoder 200 may be contemplated. The encoder 200 may be described below for purposes of clarity without describing all expected variations.

The video sequence may go through pre-encoding processing (201), for example, applying a color transform to the input color picture (e.g., conversion from RGB 4:4:4 to YCbCr 4:2:0) or performing a remapping of the input picture components in order to get a signal distribution more resilient to compression (for instance using a histogram equalization of one of the color components). Metadata may be associated with the pre-processing and attached to the bitstream.

In the encoder 200, a picture may be encoded by the encoder elements as described below. The picture to be encoded may be partitioned (202) and processed in units of, for example, coding units (CUs). Each unit may be encoded using, for example, either an intra or inter mode. If a unit is encoded in an intra mode, the encoder may perform intra prediction (260). In an inter mode, the encoder may perform motion estimation (275) and/or compensation (270). The encoder may decide (205) which one of the intra mode or inter mode to use for encoding the unit and may indicate the intra/inter decision by, for example, a prediction mode flag. Prediction residuals may be calculated, for example, by subtracting (210) the predicted block from the image block.

The prediction residuals may be transformed (225) and/or quantized (230). The quantized transform coefficients, as well as motion vectors and other syntax elements, are entropy coded (245) to output a bitstream. The encoder may skip the transform and apply quantization directly to the non-transformed residual signal. The encoder may bypass both transform and quantization, i.e., the residual may be coded directly without the application of the transform or quantization processes.

The encoder may decode an encoded block to provide a reference for further predictions. The quantized transform coefficients may be de-quantized (240) and may be inverse transformed (250), for example to decode prediction residuals. Combining (255) the decoded prediction residuals and the predicted block, an image block may be reconstructed. In-loop filters (265) may be applied to the reconstructed picture to perform, for example, deblocking/SAO (Sample Adaptive Offset) filtering to reduce encoding artifacts. The filtered image may be stored at a reference picture buffer (280).

FIG. 3 is a diagram showing an example of a video decoder. In example decoder 300, a bitstream may be decoded by the decoder elements as described below. Video decoder 300 may perform a decoding pass reciprocal to the encoding pass as described in FIG. 2. The encoder 200 may also generally perform video decoding as part of encoding video data. For example, the encoder 200 may perform one or more of the video decoding steps presented herein. The encoder may reconstruct the decoded images, for example, to maintain synchronization with the decoder with respect to one or more of the following: reference pictures, entropy coding contexts, and/or other decoder-relevant state variables.

In particular, the input of the decoder includes a video bitstream, which may be generated by video encoder 200. The bitstream may be entropy decoded (330) to obtain transform coefficients, motion vectors, and/or other coded information. The picture partition information may indicate how the picture is partitioned. The decoder may divide (335) the picture according to the decoded picture partitioning information. The transform coefficients may be de-quantized (340) and inverse transformed (350) to decode the prediction residuals. Combining (355) the decoded prediction residuals and the predicted block, an image block may be reconstructed. The predicted block may be obtained (370) from intra prediction (360) or motion-compensated prediction (i.e., inter prediction) (375). In-loop filters (365) may be applied to the reconstructed image. The filtered image may be stored at a reference picture buffer (380).

The decoded picture may go through post-decoding processing (385), for example, an inverse color transform (for example conversion from YCbCr 4:2:0 to RGB 4:4:4) or an inverse remapping performing the inverse of the remapping process performed in the pre-encoding processing (201). The post-decoding processing may use metadata derived in the pre-encoding processing and signaled in the bitstream.

An encoder or a decoder described herein may be an example. One or more other devices (for example, an autonomous vehicle, a robotics, etc.) may be built based on a neural network model. For example, the one or more devices may include a neural network-based component(s) and/or may detect an object around. The component(s) may involve an update of a network parameter(s) if the one or more devices enter an environment.

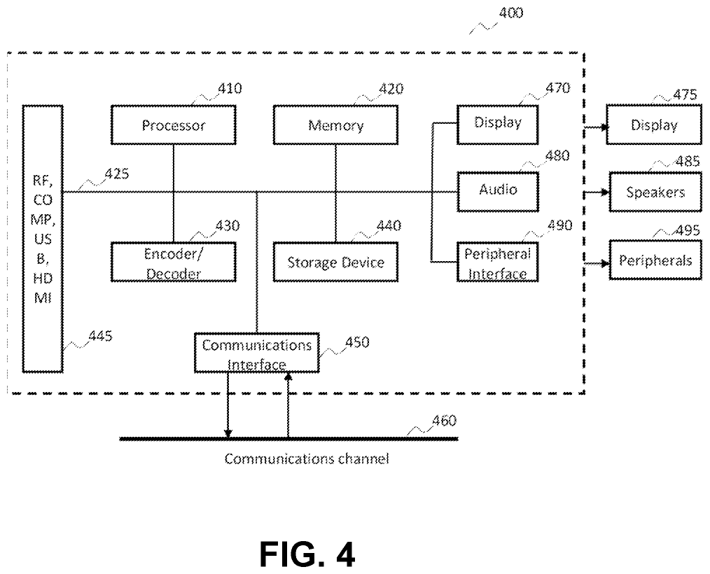

FIG. 4 is a diagram showing an example of a system in which various aspects and examples described herein may be implemented. System 400 may be embodied as a device including the various components described below and may be configured to perform one or more of the aspects described in this document Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 400, singly or in combination, may be embodied in a single integrated circuit (IC), multiple ICs, and/or discrete components. For example, in at least one example, the processing and encoder/decoder elements of system 400 may be distributed across multiple ICs and/or discrete components. In various examples, the system 400 may be communicatively coupled to one or more other systems, or other electronic devices, via, for example, a communications bus or through dedicated input and/or output ports. In various examples, the system 400 may be configured to implement one or more of the aspects described in this document.

The system 400 may include at least one processor 410 configured to execute instructions loaded therein for implementing, for example, the various aspects described in this document. Processor 410 may include embedded memory, input output interface, and various other circuitries as known in the art. The system 400 may include at least one memory 420 (e.g., a volatile memory device, and/or a non-volatile memory device). System 400 may include a storage device 440, which may include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 440 may include an internal storage device, an attached storage device (including detachable and non-detachable storage devices), and/or a network accessible storage device, as non-limiting examples.

System 400 may include an encoder/decoder module 430 configured, for example, to process data to provide an encoded video or decoded video, and the encoder/decoder module 430 may include its own processor and memory. The encoder/decoder module 430 may represent module(s) that may be included in a device to perform the encoding and/or decoding functions. A device may include one or both of the encoding and decoding modules. The encoder/decoder module 430 may be implemented as a separate element of system 400 or may be incorporated within processor 410 as a combination of hardware and software as known to those skilled in the art.

Program code to be loaded onto processor 410 or encoder/decoder 430 to perform the various aspects described in herein may be stored in storage device 440 and subsequently loaded onto memory 420 for execution by processor 410. In accordance with various examples, one or more of processor 410, memory 420, storage device 440, and encoder/decoder module 430 may store one or more of various items during the performance of the processes described in this document. Such stored items may include, but are not limited to, the input video, the decoded video or portions of the decoded video, the bitstream, matrices, variables, and intermediate or final results from the processing of equations, formulas, operations, and operational logic.

In examples, memory inside of the processor 410 and/or the encoder/decoder module 430 may be used to store instructions and to provide working memory for processing that is needed during encoding or decoding. In examples, a memory external to the processing device (for example, the processing device may be either the processor 410 or the encoder/decoder module 430) may be used for one or more of these functions. The external memory may be the memory 420 and/or the storage device 440, for example, a dynamic volatile memory and/or a non-volatile flash memory. In examples, an external non-volatile flash memory may be used to store the operating system of, for example, a television. In examples, a fast external dynamic volatile memory such as a RAM may be used as working memory for video coding and decoding operations, such as, for example, MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or WC (Versatile Video Coding, a new standard being developed by JVET, the Joint Video Experts Team).

The input to the elements of system 400 may be provided through various input devices as indicated in block 445. Such input devices may include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 4, may include composite video.

In various examples, the input devices of block 445 may have associated respective input processing elements as known in the art. For example, the RF portion may be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which may be referred to as a channel in certain examples, (iv) demodulating the downconverted and band-limited signal, (v) performing error correction, and (vi) demultiplexing to select the desired stream of data packets. The RF portion of various examples may include one or more elements to perform these functions, for example, frequency selectors, signal selectors, band-limiters, channel selectors, filters, downconverters, demodulators, error conectors, and demultiplexers. The RF portion may include a tuner that performs various of these functions, including, for example, downconverting the received signal to a lower frequency (for example, an intermediate frequency or a near-baseband frequency) or to baseband. In a set-top box example, the RF portion and its associated input processing element may receive an RF signal transmitted over a wired (for example, cable) medium, and may perform frequency selection by filtering, downconverting, and filtering again to a desired frequency band.

Various examples may rearrange the order of the above-described (and other) elements, remove some of these elements, and/or add other elements performing similar or different functions. Adding elements may include inserting elements in between existing elements, such as, for example, inserting amplifiers and an analog-to-digital converter. In various examples, the RF portion may include an antenna.

Additionally, the USB and/or HDMI terminals may include respective interface processors for connecting system 400 to other electronic devices across USB and/or HDMI connections. It is to be understood that various aspects of input processing, for example, Reed-Solomon error correction, may be implemented, for example, within a separate input processing IC or within processor 410 as necessary. Similarly, aspects of USB or HDMI interface processing may be implemented within separate interface ICs or within processor 410 as necessary. The demodulated, error corrected, and demultiplexed stream may be provided to various processing elements, including, for example, processor 410, and encoder/decoder 430 operating in combination with the memory and storage elements to process the data stream as necessary for presentation on an output device.

Various elements of system 400 may be provided within an integrated housing. Within the integrated housing, the various elements may be interconnected and transmit data there between using suitable connection arrangement 425, for example, an internal bus as known in the art, including the Inter-IC (12C) bus, wiring, and printed circuit boards.

The system 400 may include communication interface 450 that enables communication with other devices via communication channel 460. The communication interface 450 may include, but is not limited to, a transceiver configured to transmit and to receive data over communication channel 460. The communication interface 450 may include, but is not limited to, a modem or network card and the communication channel 460 may be implemented, for example, within a wired and/or a wireless medium.

Data may be streamed, or otherwise provided, to the system 400, in various examples, using a wireless network such as a Wi-Fi network, for example IEEE 802.11 (IEEE refers to the Institute of Electrical and Electronics Engineers). The Wi-Fi signal of these examples may be received over the communications channel 460 and the communications interface 450 which are adapted for Wi-Fi communications. The communications channel 460 of these examples may be typically connected to an access point or router that provides access to external networks including the Internet for allowing streaming applications and other over-the-top communications. Other examples may provide streamed data to the system 400 using a set-top box that delivers the data over the HDMI connection of the input block 445. Still other examples may provide streamed data to the system 400 using the RF connection of the input block 445. As indicated above, various examples may provide data in a non-streaming manner. Additionally, various examples may use wireless networks other than Wi-Fi, for example a cellular network or a Bluetooth network.

The system 400 may provide an output signal to various output devices, including a display 475, speakers 485, and other peripheral devices 495. The display 475 of various examples includes one or more of, for example, a touchscreen display, an organic light-emitting diode (OLED) display, a curved display, and/or a foldable display. The display 475 may be for a television, a tablet, a laptop, a cell phone (mobile phone), or other device. The display 475 may be integrated with other components (for example, as in a smart phone), or separate (for example, an external monitor for a laptop). The other peripheral devices 495 may include, in various examples of examples, one or more of a stand-alone digital video disc (or digital versatile disc) (DVR, for both terms), a disk player, a stereo system, and/or a lighting system. Various examples may use one or more peripheral devices 495 that provide a function based on the output of the system 400. For example, a disk player may perform the function of playing the output of the system 400.

In various examples, control signals may be communicated between the system 400 and the display 475, speakers 485, or other peripheral devices 495 using signaling such as AV.Link, Consumer Electronics Control (CEC), or other communications protocols that enable device-to-device control with or without user intervention. The output devices may be communicatively coupled to system 400 via dedicated connections through respective interfaces 470, 480, and 490. Alternatively, the output devices may be connected to system 400 using the communications channel 460 via the communications interface 450. The display 475 and speakers 485 may be integrated in a single unit with the other components of system 400 in an electronic device such as, for example, a television. In various examples, the display interface 470 may include a display driver, such as, for example, a timing controller (T Con) chip.

The display 475 and speakers 485 may be separate from one or more of the other components, for example, if the RF portion of input 445 is part of a separate set-top box. In various examples in which the display 475 and speakers 485 are external components, the output signal may be provided via dedicated output connections, including, for example, HDMI ports, USB ports, or COMP outputs.

The examples may be carried out by computer software implemented by the processor 410 or by hardware, or by a combination of hardware and software. As a non-limiting example, the examples may be implemented by one or more integrated circuits. The memory 420 may be of any type appropriate to the technical environment and may be implemented using any appropriate data storage technology, such as optical memory devices, magnetic memory devices, semiconductor-based memory devices, fixed memory, and removable memory, as non-limiting examples. The processor 410 may be of any type appropriate to the technical environment and may encompass one or more of microprocessors, general purpose computers, special purpose computers, and processors based on a multi-core architecture, as non-limiting examples.

Various implementations may involve decoding. Decoding, as used in this application, may encompass one or more (e.g., all or part) of the processes performed, for example, on a received encoded sequence in order to produce a final output suitable for display. In various examples, such processes may include one or more of the processes performed by a decoder, for example, entropy decoding, inverse quantization, inverse transformation, and/or differential decoding. In various examples, such processes may include processes performed by a decoder of various implementations described in this application, for example, obtain a compressed NN model with a quantized NN layer associated with a weight matrix having a first dimensionality; obtain a weight matrix shape of the original or uncompressed weight matrix shape (for example, in signaled arrangement metadata); decode cluster inliers and cluster outliers; reshape/restore the weight matrix to the original or uncompressed shape (for example, by increasing dimensionality); and decode the NN layer based on the reshaped weight matrix with inliers and outliers, etc.

In examples, in one example decoding may refer to entropy decoding. In examples, decoding may refer to differential decoding. In examples, decoding may refer to a combination of entropy decoding and differential decoding. Whether the phrase decoding process is intended to refer to a subset of operations or refer to the broader decoding process will be clear based on the context of the specific descriptions and is believed to be well understood by those skilled in the art.

Various implementations may involve encoding. In an analogous way to the above discussion about decoding, encoding as used in this application may encompass one or more (e.g., all or part) of the processes performed, for example, on an input video sequence in order to produce an encoded bitstream. In various examples, such processes may include one or more of the processes performed by an encoder, for example, partitioning, differential encoding, transformation, quantization, and/or entropy encoding. In various examples, such processes may include processes performed by a coding device, such as an encoder, of various implementations described in this application, for example, obtain an NN model including an NN layer associated with a weight matrix; identify a dimensionality of the weight matrix; reshape, flatten or rearrange the weight matrix (for example, to reduce the dimensionality of the weight matrix); identify and separate outliers from clusters, code (for example, including quantize, such as by scaler or vector quantization) the NN layer based on the reshaped weight matrix and cluster inliers; perform prediction based on the reshaped weight matrix, transmit weight matrix arrangement information (for example, original and reshaped dimensionality), outlier information, prediction information, and coding information of the weight matrix in a bitstream, etc.

As further examples, in examples encoding may refer to entropy encoding. In examples, encoding may refer to differential encoding. In examples, encoding may refer to a combination of differential encoding and entropy encoding. Whether the phrase encoding process may be intended to refer to a subset of operations or refer to the broader encoding process will be clear based on the context of the specific descriptions and is believed to be well understood by those skilled in the art.

Note that syntax elements as used herein, for example, arrangement metadata, inliers, outliers, outlier index, codebook, code index, output file, compressed file, etc., are descriptive terms. As such, they may not preclude the use of other syntax element names.

If a figure is presented as a flow diagram, it should be understood that it also provides a block diagram of a corresponding apparatus. Similarly, if a figure is presented as a block diagram, it should be understood that it also provides a flow diagram of a corresponding method/process.

Various examples may refer to rate distortion optimization. During the encoding process, the balance or trade-off between the rate and distortion may be considered, often given the constraints of computational complexity. The rate distortion optimization may be formulated. For example, the rate distortion optimization may be formulated as minimizing a rate distortion function. The rate distortion function may be a weighted sum of the rate and of the distortion. The rate distortion may be optimized based on an extensive testing of one or more (for example all) encoding options, including one or more (for example all) considered modes or coding parameters values, with a complete evaluation of their coding cost and related distortion of the reconstructed signal after coding and decoding. Faster approaches may be used, to save encoding complexity, in particular with computation of an approximated distortion based on the prediction or the prediction residual signal, not the reconstructed one. Mix of these two approaches may be used, such as by using an approximated distortion for only some of the possible encoding options, and a complete distortion for other encoding options. Other approaches may evaluate a subset of the possible encoding options. More generally, many approaches may employ any of a variety of techniques to perform the optimization, but the optimization may not complete an evaluation of the coding cost and/or related distortion.

The implementations and aspects described herein may be implemented in, for example, a method or a process, an apparatus, a software program, a data stream, or a signal. Even if only discussed in the context of a form of implementation (for example, discussed as a method), the implementation of features discussed may be implemented in other forms (for example, an apparatus or program). An apparatus may be implemented in, for example, appropriate hardware, software, and/or firmware. The methods may be implemented in, for example, a processor, which refers to processing devices in general, including, for example, a computer, a microprocessor, an integrated circuit, or a programmable logic device. Processors may include communication devices, such as, for example, computers, cell phones, portable/personal digital assistants (PDAs), and other devices that facilitate communication of information between end-users.

Reference to one example, an example, one embodiment, an embodiment, one implementation or an implementation, as well as other variations thereof, means that a particular feature, structure, characteristic, and so forth described in connection with the example is included in at least one example. Thus, the appearances of the phrase in one embodiment, in an embodiment, in an example, in one example, in one implementation, or in an implementation, as well any other variations, appearing in various places throughout this application are not necessarily all referring to the same example.

Additionally or alternatively, this application may refer to determining various pieces of information. Determining the information may include one or more of, for example, estimating the information, calculating the information, predicting the information, or retrieving the information from memory. Obtaining may include receiving, retrieving, constructing, generating, and/or determining.

Further, this application may refer to accessing various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to receiving various pieces of information. Receiving may be, as with accessing, intended to be a broad term. Receiving the information may include one or more of, for example, accessing the information, or retrieving the information (for example, from memory). Further, receiving may be involved, in one way or another, during operations such as, for example, storing the information, processing the information, transmitting the information, moving the information, copying the information, erasing the information, calculating the information, determining the information, predicting the information, and/or estimating the information.

It is to be appreciated that the use of any of the following /, and/or, and at least one of, for example, in the cases of AB, A and/or B and at least one of A and B, may be intended to encompass the selection of the first listed option (A) only, or the selection of the second listed option (B) only, or the selection of both options (A and B). As a further example, in the cases of A, B, and/or C and at least one of A, B, and C, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word signal refers to, among other things, indicating something to a corresponding decoder. For example, in some examples the encoder signals (e.g., to a decoder) arrangement metadata, outlier information (for example, outliers, outlier index), quantization information (for example, codebook, code index), prediction information (for example, in an output file or a compressed file), etc. In this way, in an example, the same parameter may be used at the encoder side and/or the decoder side. For example, an encoder may transmit (for example explicit signaling) a particular parameter to a decoder. The decoder may use the same particular parameter. Conversely, if the decoder has the particular parameter as well as others, signaling may be used without transmitting (for example implicit signaling) to allow the decoder to know and select the particular parameter. By avoiding transmission of any actual functions, a bit savings may be realized in various examples. It is to be appreciated that signaling may be accomplished in a variety of ways. For example, one or more syntax elements, flags, and so forth are used to signal information to a corresponding decoder in various examples. While the preceding relates to the verb form of the word signal, the word signal may be used herein as a noun.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described example. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

Neural networks (NNs) may be used in an artificial intelligence (AI) related application(s). Neural network models may be compressed, for example, for multi-media signal processing related application(s), such as visual object classification, video summarization, image compression, acoustic scene classification, etc. Neural networks (for example, well trained NNs for different applications) may be stored and/or transmitted, for example, to enable a variety of applications. A compressed NN representation (NNR) may provide, for example, an efficiently coded, interpretable, and/or interoperable representation of trained NNs.

An NN model may include one or more layers. Types of NN layers (for example, in compressed NNRs for multi-media signal processing related applications) may include, for example, a convolutional NN (CNN) layer, a fully connected (FC) layer, and/or a bias layer. A trained NN model may be represented, for example, by a weight tensor (for example, a matrix, such as a multi-dimensional matrix) for CNN, FC, and/or bias layers.

In examples of an NN formulation, a parameter L may denote the number of layers, {W₁, . . . , W_{L}} may denote the weight matrices, {b₁, . . . , b_{L}} may denote the biases, and {g, . . . , g_{L}} may denote non-linearities. The output of k^{th} layer y^{k+1} may be written (for example, based on weights, biases, and/or non-linearities), for example, in accordance with Equation (1):

y^{k+1}=gₖ(Wₖy^{k}+bₖ) (1)

where y¹=x may be the input to a deep neural network (DNN). Depth may refer to dimensions (for example, the number of columns and/or rows) of weight matrices from different layers. A DNN may be or may include an NN with a depth that may be large (for example, very large, such as several hundred).

A layer may be represented as a weight tensor (for example, a matrix, such as a multi-dimensional matrix), which may be parameterized with a kernel matrix/tensor, the number of input features or channels, and/or the number of output features or channels. A kernel may be a weight matrix/tensor with a (for example, limited) size (for example, 3×3, 5×5, 3×3×3, etc.). A kernel may cover a (for example, local) neighborhood of the matrix/tensor size, for example, if conducting convolution or if filtering on (for example, high) dimensional output data/signals (for example, from a previous NN layer or an input signal, such as an original input signal). Table 1 illustrates an example categorization of different kinds or types of weight matrices/tensors from different types of NN layers.

TABLE 1
Examples of weight tensor dimensions for different types of NN layers

| Input signal type | Layer type | Weight tensor dimension |
|---|---|---|
| 3D signal: video/point cloud | Convolutional | K₁ × K₂ × K₃ × Cᵢₙ × Cₒᵤₜ |
| 2D signal: image | Convolutional | K₁ × K₂ × Cᵢₙ × Cₒᵤₜ |
| 1D signal: audio | Convolutional | K₁ × Cᵢₙ × Cₒᵤₜ |
| | Fully connected | Cᵢₙ × Cₒᵤₜ |
| | Bias | Cₒᵤₜ |

K1, K2, and K3 may represent the dimensions of a convolutional kernel. Cᵢₙ and Cₒᵤₜ may denote the number of input and output features or channels, respectively. In examples, a weight coefficient may be stored, for example, as a 32 bits floating point number. In examples, the value of a weight coefficient may be between −1 and +1. In examples, the value may be other than (for example, beyond) the range −1 to +1. A weight tensor may be a data object or a signal to be compressed for NNR.

NNR-related operations may include, for example, network pruning, sparsity regularization, weight tensor compression, and/or entropy coding.

Network pruning may include or may be implemented by, for example, transferring a network (for example, an original network) to another (for example, a smaller) NN architecture (for example, of equivalent or similar classification capability and performance), for example, via distillation and/or weight pruning. A pruned network may be retrained, for example, for performance of the pruned network (for example, to maintain and/or correct performance).

Sparsity regularization may, for example, increase the sparsity of weight tensors (for example, during a training process). Sparsity regularization may be implemented, for example, by introducing an additional sparsity regularization term on a training loss.

Weight tensor compression may include or may be implemented by, for example, one or more of the following: matrix factorization, transform coding, scalar quantization, and/or vector quantization.

Matrix factorization may include or may be implemented by, for example, arranging a weight tensor as a matrix and converting the matrix into smaller matrices, for example, using one or more types of matrix factorization, such as singular value decomposition (SVD).

Transform coding may include or may be implemented by, for example, transforming weights to frequency domain (for example, before quantization).

Scalar quantization may include or may be implemented by, for example, treating a weight tensor as a list of real values and/or generating a code book, for example, by clustering scalar points into (for example, several) clusters. Weights may be quantized, for example, to the cluster center (for example to the closest cluster center).

Vector quantization for weight tensor compression may arrange the weight matrix as a list of vectors (for example, multi-dimensional points) and/or generating a code book, for example, by clustering points into several clusters. Scalar quantization may be, for example, a type of vector quantization, where the dimension may be one.

Entropy coding may include or may be implemented by, for example, performing compression (for example, further compression, such as in a subsequent or final step).

Scalar quantization and/or vector quantization may (for example, be used to) compress NN (for example, CNN) parameters. There may be redundancies in neural network parameters. Weights within a layer may be predicted (for example, accurately predicted) by a subset (for example, a small subset, such as 5%) of network parameters. K-means based quantization (for example, including scalar quantization and vector quantization) may reduce redundancy and compress weight tensors. Scalar quantization may quantize one-dimensional tensors. Scalar quantization may (for example, be used to) quantize multi-dimensional tensors by (for example, first) flattening a multi-dimensional tensor into a one-dimensional tensor. Quantization error (for example, for clustering-based quantization) may impact performance. Hessian-weighted k-means clustering may (for example, be used to) cluster network parameters, for example, to decrease quantization error. K-means-based scalar quantization may achieve, for example, an 8-16 times compression rate on fully connected layers (for example, with a minor top-5 accuracy drop within 0.5%). Scalar quantization may flatten a multidimensional tensor into a one-dimensional tensor. An index may be stored, for example, for each value of a flattened multidimensional tensor. There may be redundancy (for example, significant redundancy) between different filters and feature channels. Vector quantization may arrange a weight tensor into multi-dimensional vectors, which may reduce the space needed to store an index (for example, if a multidimensional tensor is flattened into a one-dimensional tensor for scalar quantization).

Vector quantization may compress NNs, for example, up to 24 times (for example, while maintaining the top-5 accuracy drop within 1%). Vector quantization (for example, universal vector quantization) may utilize randomized lattice quantization. Distortion of a compressed model may be independent of the NN model/NN layer to be compressed, for example, based on vector quantization using uniform random dithering. A gap of the rate from the rate-distortion bound at a distortion level may be, for example, less than or equal to 0.754 bits per sample for a finite dimension. Pruning may yield, for example, a 10 times compression ratio. Vector quantization with randomized lattice quantization may (for example, further) yield the compression ratio, for example, up to 50 times, with marginal accuracy loss. Scalar quantization and vector quantization may reduce memory usage and may reduce computational complexity during inference, for example, by using (for example, directly using) the codebook and index during computation. In examples, an NNR model using scalar quantization and/or vector quantization (for example, as described herein) may, for example, reduce processing time by four times using a quarter of the run-time memory, for example, compared to processing time and runtime memory for an uncompressed NN model.

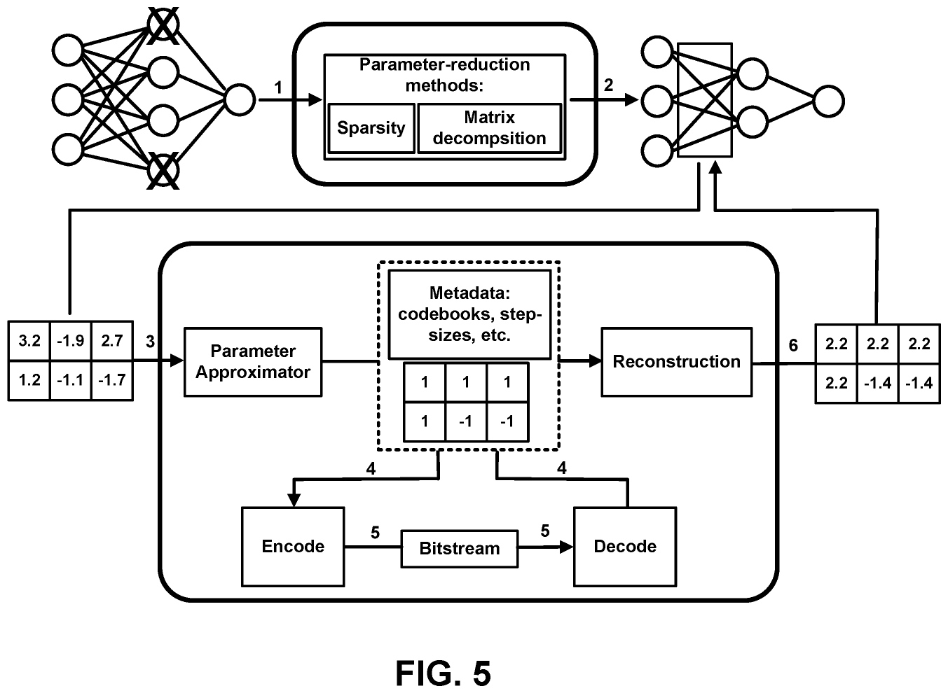

FIG. 5 illustrates an example of a neural network codec, for example, an NNR codec that may provide neural network compression. Numbers 1-6 are provided for reference. Numbers 1 and 2 may indicate input and output, respectively, for one or more types of parameter reduction (for example, sparsity and/or matrix decomposition), which may be implemented as a preprocessing step on an input neural network. Numbers 3-6 may indicate input and/or output for other processing steps. For example, number 3 may refer to input provided to a parameter approximator. Number 4 may refer to input (such as metadata that may include codebooks, step sizes, etc.) to an encoder. Number 5 may refer to an encoded bitstream provided to a decoder. Number 6 may refer to the output of decoding reconstruction. Encoding and decoding (for example, as shown in FIG. 5) may represent an entropy codec.

A processing pipeline may use an NN model. An NN model may be a collection of NN layers (for example, with a particular architecture). An NN model may receive one or more inputs (for example, image/video, point clouds, audio, etc.) and/or may produce one or more outputs (for example, an enhanced version of the input signal, a classified category of the input, etc.). An NN layer may have an input and an output.

An NN model may be implemented in multiple (for example, two) stages. A first stage may be a training stage, which may be implemented to determine parameters for an NN model. In examples, an NN model may be implemented for an architecture. NN model parameters may be determined through training, for example, over a training dataset. A second stage of operation (for example, for a trained NN model) may be a test or inference stage. An NN model may be implemented in a stage, for example, where the NN model may be treated like a solver. In examples, a training stage may be performed in a way to overfit the NN model to a particular input NN model parameters obtained in the training stage may be a side product in producing the output and may not be applied in an inference stage. In examples, training and inference stages may be interleaved, which may be referred to as online learning. MPEG NNR (for example, compression of an NN model) may be implemented, for example, in multiple (for example, two) stages and/or in a single stage (for example, online learning, such as to refine NN model parameters).

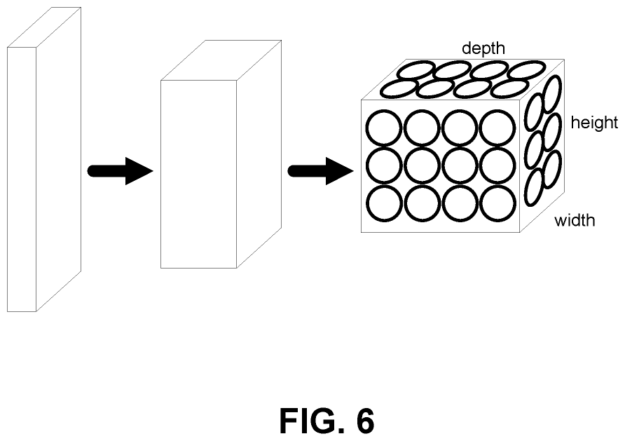

FIG. 6 illustrates an example of CNN layers arranged in 3D. A CNN layer may include (for example, may be defined by) convolutional kernels, the number of input and output channels and a depth of a convolution filter. A convolutional kernel may be defined by a width and height, which may be referred to as hyper-parameters. Input channels and output channels may be referred to as hyper-parameters. A depth of a convolution filter (for example, the number of input channels) may be equal to the number channels (for example, the depth) of the input feature map. A kernel may be referred to as a tensor, for example, if the number of input/output channels is not equal to be one (1). A kernel may correspond to a 3D volume of neurons.

Scalar quantization and vector quantization may be effective quantization in NN compression. In examples of scalar quantization and vector quantization for NN compression, a weight tensor may be treated as a list of d-dimensional points. The points may be clustered into one or more clusters. A point may be represented by the center of the cluster. A weight tensor may be represented by a codebook of the cluster center and a list of indices recording the corresponding cluster center for a (for example, each) point. The compression rate may be controlled by the number of clusters. The distortion of the NN may depend on, for example, the number of clusters and the clustering methods.

K-means-based methods may be used for clustering weight tensors. A k-means-based method may be sensitive to outliers. Outliers may skew the center of a cluster (for example, far away from the members) and may result in (for example, large) quantization errors. An outlier in a cluster may cause/render a distortion of an NN in NN weights quantization. Outliers may be dealt with before clustering (for example, regardless of a selected clustering method), for example, to reduce quantization errors.

Vector quantization may quantize layers. For example, vector quantization may quantize fully connected layers, for example, where major parameters may be represented as two-dimensional matrices. Higher dimensional weight tensors for some types of layers, such as CNN layers, may involve rearranging weights into two-dimensional matrices, where a row/column of the matrix represents a point. A clustering-based method may try to find a correlation between points, for example, to reduce redundancy between the data. A matrix may be arranged. An arrangement of a matrix may, for example, result in a correlation (for example, a large correlation) between the rows/columns after conversion to two-dimensional matrices.

Clustering-based quantization (for example, hierarchical or k-means clustering-based quantization) may be performed, for example, with separation and/or removal of outliers. Clustering-based quantization, as disclosed herein, may address tensor arrangement of CNN layers and/or may reduce the impact of outliers on clustering (for example, during scalar quantization and/or vector quantization of NN weights). A distribution of NN weights may be analyzed, for example, to separate outliers from inliers. In examples, detected outlier(s) may be removed. In examples, an outlier and an inlier may be classified into (for example, two) non-overlapping categories. A K-means based process may be performed on outlier and inlier categories, for example, during clustering in scalar quantization and vector quantization of NN weights.

An NN model may be a type of NN model utilized to process video, audio, medical, speech, etc. An NN model may represent, for example, a data model, a mathematical model comprising parameters and/or functions, etc.

Clustering-based quantization may detect an outlier(s) in weight tensors and/or may code the outlier(s) and the remaining weights (for example, inliers), for example, separately. Weight tensor and weight matrix may be used interchangeably herein.

A weight rearrangement method may rearrange weights for NN layers (for example, for CNN layers). A kernel (for example, for a CNN layer) may be flattened into a vector. A correlation between kernels may be preserved, for example, by treating one or more kernels across a channel as a point during clustering.

Network weights may be rearranged into lower-dimensional (for example 2D or 1D) matrices, for example, for higher dimensional weight tensors for CNN layers. Vector quantization may be performed row-wisely (or column-wisely), for example, on the multi-dimensional matrices. The arrangement may result in a correlation between the row vectors (or column vectors) in the resulting matrices.

An NN model layer may be coded based on rearranged, reshaped or flattened (for example, reduced dimensionality) weight tensor/matrix. Cluster inliers and outliers may be coded separately. Coding, as used herein, may include quantization, such as scalar quantization and/or vector quantization. An NN layer may include, for example, a convolutional NN layer, a fully connected layer, or a bias layer.

FIG. 7 illustrates an example of clustering-based quantization with outlier removal. Clustering-based quantization may reshape a weight matrix/tensor in an NN layer, for example by flattening or rearranging a dimensionality of the weight matrix/tensor, which may reduce a dimensionality of the weight matrix/tensor. For example, dimensionality may be reduced from a multi-dimension to a lower dimension (for example, 4D to 3D, 4D to 2D, 3D to 2D, 2D to 1D, 3D to 1D, 4D to 1D, etc.). An input weight tensor may be rearranged into one or more sub-matrices, for example, with a shape n×dₜ, to perform clustering-based quantization. Sub-matrices may have different shapes. For example, dₜ may differ or vary among sub-matrices. Tensor arrangement may be associated with compression (for example the performance of compression). The arrangement of an input tensor may be based on the type of input layer. A matrix may be treated as n points in [symbol] ^{d}^{ₜ}.

An outlier detection process may be performed. For example, an outlier detection may identify/detect an outlier(s). Detected or identified outlier(s) may be sent to a coding device, such as an encoder, for encoding and/or compression. An inlier may represent a weight that is not an outlier. Remaining points (for example, non-outlier or inlier points) may be provided to a scalar quantization process or a vector quantization process for quantization. Remaining points may be quantized using scalar quantization (for example, as shown in FIG. 7), for example, if the remaining points are one-dimensional scalars (for example, dₜ=1). Remaining points may be quantized using vector quantization, for example, if the remaining points are multi-dimensional scalars (for example, dₜ>1). The outlier and quantization results may be combined, for example, to form an output bitstream. For example, the output bitstream may include an integrated quantization (for example, integrating the quantization of the inlier and outlier) and/or an integrated output of the weight tensor. It may be observed, for example, with reference to an example encoder shown in FIG. 2, that clustering-based quantization shown in FIG. 7 may be followed by entropy coding, which may generate a coded bitstream that represents a weighted tensor. The coded bitstream (for example, including an indication of an original dimensionality and a reduced dimensionality of a weight matrix) may be provided to a coding device, such as a decoder.

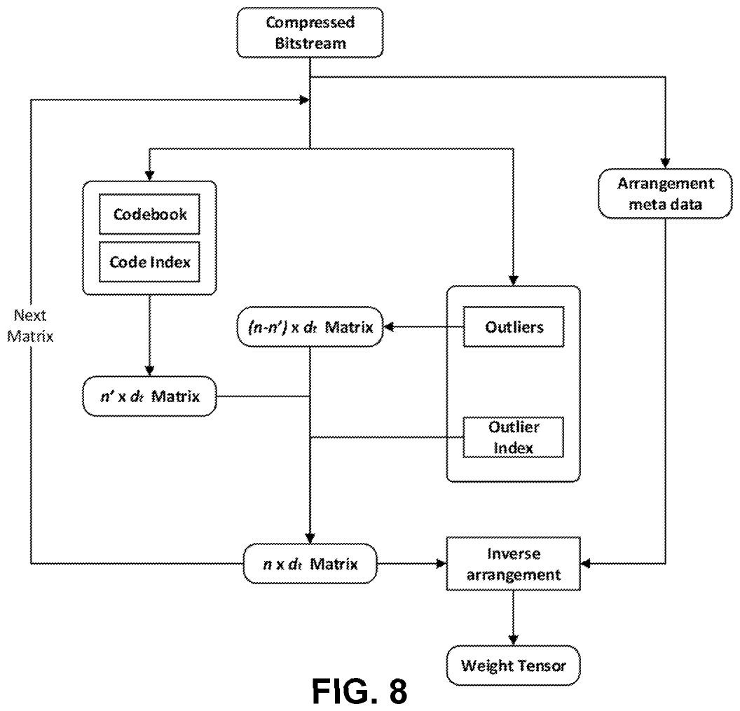

FIG. 8 illustrates an example of inverse quantization. A decoder (such as an example decoder shown in FIG. 3 operating as shown in FIG. 8) may obtain a compressed NN model including a quantized NN layer associated with a weight matrix/tensor. Decoding may extract arrangement meta information from compressed NN model input. The compressed NN model input may be a compressed bitstream. The compressed NN model input may be in the form of a file (for example, an output including a compressed weight tensor created by a quantization process shown in FIG. 7), to receive or obtain a shape (for example, dimensionality) of the original or uncompressed weight tensor (for example, to the original dimensionality, and/or to the original dimensions of the weight tensor, such as K₁×K₂ or K₁×K₂×K₃) and the tensor arrangement information. Decoding may reshape a coded weight matrix/tensor based on the original or uncompressed shape, which may include an original number of rows and columns. In examples, dimensionality may be reconstructed, for example, by increasing from a lower dimension to a higher dimension (for example, 3D to 4D, 2D to 4D, 2D to 3D, 1D to 2D, 1 D to 3D, 1D to 4D, etc.). The NN layer may be decoded based on the reshaped weight matrix. The location of the sub-matrices in the weight tensor may be derived, for example, based on the shape of the weight matrix/tensor and the split information.

For example, the location of the sub-matrices in the weight tensor may be derived by inversing the arrangement process. Inliers for a sub-matrix (for example, stored in the compressed bitstream, such as the compressed file or the output file) may be recovered (for example, to a matrix of shape) based on or by using, for example, the code book and the code index. The inlier may represent one or more (e.g., all) weights that remained after outlier removal (for example, not removed as the outliers).

Scalar quantization may rearrange a weight tensor as one-dimensional scalars. Vector quantization may rearrange a weight tensor as one or more matrices.

A weight tensor may have a shape. A weight tensor (for example, given to a shape) may be flattened and/or may be reshaped into a matrix, such as a matrix W in [symbol] ^{n×1}. The parameter n may be the number of elements in the tensor. Scalar quantization may cluster the n elements into k clusters, for example, in accordance with Equation (2):

min Σᵢ₌₁^{N}Σⱼ^{k}δᵢⱼh(wᵢ−cⱼ) (2)

Parameter δᵢⱼ may be a binary value that indicates whether the original weights w; belongs to cluster j. Parameter cⱼ (for example, cⱼ=Σᵢ₌₁^{N}g(δᵢⱼ, wᵢ)) may be or may include a code of the cluster. Parameter cⱼ may be defined as a centroid or median, for example, based on selection of g. In examples, cⱼ=Σᵢ₌₁^{N}g(δᵢⱼ, wᵢ) may be the center of a cluster, for example, if g is a function that converts and/or maps one or more (for example, all) the points (for example, inliers) in a cluster to a point. Parameter h may be a measure of a distance between a value (for example an original value) and a cluster center.

Scalar quantization may rearrange a weight tensor as one-dimensional scalars. Vector quantization may rearrange a weight tensor to form one or multiple matrix/matrices of shape n×dₜ. A point may be a dₜ dimensional vector (for example, rather than a scalar). Vector quantization may be formulated in accordance with Equation (2), for example, considering the difference of dimensionality. Vector quantization may be addressed with clustering, such as k-means clustering. In examples (for example, using k-means clustering), the parameter cⱼ may be the centroid of the cluster, and the parameter h may be the Euclidean distance.

The collection of the cluster centers identified during clustering may be used to form the codebook. A value(s) in the matrix may be quantized to its corresponding duster center. A quantized weight tensor may be represented with a codebook, for example, with a shape k×d_{L}, where n integer values (for example, ranging from 0 to k−1) may indicate the index of a corresponding code in the codebook for an element in the matrix. An index may be quantized with log (k) bits.

Matrices or tensors may be rearranged. In examples, multi-dimensional tensors, such as a two-dimensional tensor (or matrix) of shape Cᵢₙ×Cₒᵤₜ, the original matrix may be split into multiple subspaces. A matrix may be divided into m subspaces, for example, along the axis of Cₒᵤₜ, with a dimension dₜ (t=1, 2, . . . , m), where Σₜ₌₁^{m} dₜ=Cₒᵤₜ. FIG. 9 illustrates an example tensor rearrangement of two-dimensional weights for vector quantization. An original weight tensor (for example, as shown in FIG. 9) may have a shape Cᵢₙ=42 and Cₒᵤₜ=21. The original weight tensor may be converted, for example, into three (3) sub-matrices, with dₜ=14 (t=1, 2, 3). The matrix may (for example, additionally or alternatively) be split into two or more sub-matrices, for example, along the axis of Cᵢₙ. Vector quantization may be performed in a subspace, for example, after splitting. A subspace may be quantized (for example, quantized individually). Subspaces may have the same dimension(s). Subspaces may be combined, for example, if the subspaces have the same dimension(s). For example, three sub-matrices (for example, tensors with two dimensions) with a shape of 21×14 may be concatenated into a matrix of shape 63×14 and may be quantized, for example, quantized together.

A weight tensor (for example, for convolutional layers) may have three dimensions for a 1D signal, four dimensions for a 2D signal, and five dimensions for a 3D signal. Compression performance provided by vector quantization may be related to or based on a correlation between vectors. Weight tensor arrangements may be evaluated and/or selected, for example, to exploit correlation between vectors. For example, an arrangement (for example a first arrangement) of a tensor may provide a distinct compression performance over another arrangement (for example a second arrangement of a tensor). Redundancy may exist between filters and feature channels. Correlation between filters may be preserved, for example, by arranging the weights of CNN layers to take one or more filters as a vector for vector quantization.

In examples (for example, for 1D convolutional layers of tensor size K×Cᵢₙ×Cₒᵤₜ), a tensor may be split into m subspaces. For example, a tensor may be split into m subspaces along an input channel, for example, the Cᵢₙ dimension. Splitting a tensor into subspaces may provide m tensors of size K×dₜ×Cₒᵤₜ, where Σₜ₌₁^{m}dₜ=Cᵢₙ. Multiple dimensions (for example, the first two dimensions), may be flattened, for example, for each of m tensors, to form a dimensional vector (for example, a Kdₜ dimensional vector). The dimensional vector may provide a matrix (for example, a Kdₜ×Cₒᵤₜ matrix), for example, after transposition. One or more dₜ filters may share the same code index, which may reduce memory to store the code index. FIGS. 10A-C illustrate an example 1-D convolution tensor arrangement. For example, a 1D convolution layer with 12 input channels (for example, as shown in FIG. 10A) may be split into four matrices of shape 3K×Cₒᵤₜ (for example, as shown in FIG. 10B). Three filters may share the same code index. As shown in FIG. 10B, Filter1-filter3 may share the same code index, the next three filters may share a code index, and so on. Four codebooks may be obtained, for example, if the four matrices are quantized separately. The matrices may be concatenated (for example, concatenated together), for example, as shown by example in FIG. 10C. The four matrices may share the same codebook, and may reduce the memory for codebook storage, for example, by combining (for example, concatenating) the matrices together. A codebook may be enlarged for combined matrices, for example, to provide or maintain quantization accuracy. A split may (for example, additionally or alternatively) be conducted along the output channel, for example, Cₒᵤₜ. Vector quantization may be conducted on the sub-matrices, for example, separately/individually or on the combined matrix.

In examples (for example, for 2D convolutional layers of tensor size K₁×K₂×Cᵢₙ×Cₒᵤₜ), a tensor may be arranged into a three dimensional tensor of shape K₁K₂×Cᵢₙ×Cₒᵤₜ. In examples (for example, for 3D convolutional layers with tensor size K₁×K₂×K₃×Cᵢₙ×Cₒᵤₜ), a tensor may be rearranged to a three dimensional tensor of shape K₁K₂K₃×Cᵢₙ×Cₒᵤₜ. A high dimensional tensor may be converted to three dimensions, for example, as described herein. Weight quantization may be applied to the converted three dimensions similar to weight quantization described herein for 1D convolution layers of a tensor.

An arrangement may be recovered, for example, based on arrangement meta information, which may be stored in a file (for example, an output file referenced in FIG. 7 or a compressed file referenced in FIG. 8). Meta information may include, for example, one or more of the following: the original shape of a weight tensor; an integer that may indicate the index of the axis along which the tensor is split a list of integers that may specify the splits along the axis, for example, dₜ (t=1, 2, . . . , m); and/or the like. A list of integers may specify equal spits, for example, d₀=d₁= . . . =dₘ. Equal spits may be represented by an integer representing the dimension of the equal splits. An unequal remainder for a tensor split unevenly with a specified dimension (for example, the remainder of one or more rows after a tensor may split evenly), may be stored (for example, stored as the first or the last), and the shape may be derived from the shape and the specified dimension.

Predictive coding methods may be applied to weight tensors or matrices. A weight tensor (for example, a matrix) flattened to a 2D weight matrix may be viewed or treated as a type of image. In examples, an image-formatted weight matrix may have a component, for example, instead of or in addition to three components, such as RGB or YUV components in an image. An image-formatted weight matrix may have a particular or selected range of values, for example, instead of 8-, 10-, 12-, 24-bit, or other depths for images. Predictive coding methods used in image/video coding may be used/employed to represent a weight matrix, for example, by viewing/treating the weight matrix as an image.

In examples, a weight matrix may be partitioned into blocks of weights. Blocks of weights previously coded may be used to predict a current block of weights, for example, in a manner that may be similar to intra prediction modes, such as in, for example, MPEG AVC, HEVC, and/or WC.

In examples, a neighboring weight matrix may be predicted. A current weight matrix (for example, similar to a frame) may be predicted from a previously coded weight matrix (for example, similar to a frame), for example, in a manner that may be similar to inter prediction modes, such as in, for example, MPEG AVC, HEVC, and/or WC.

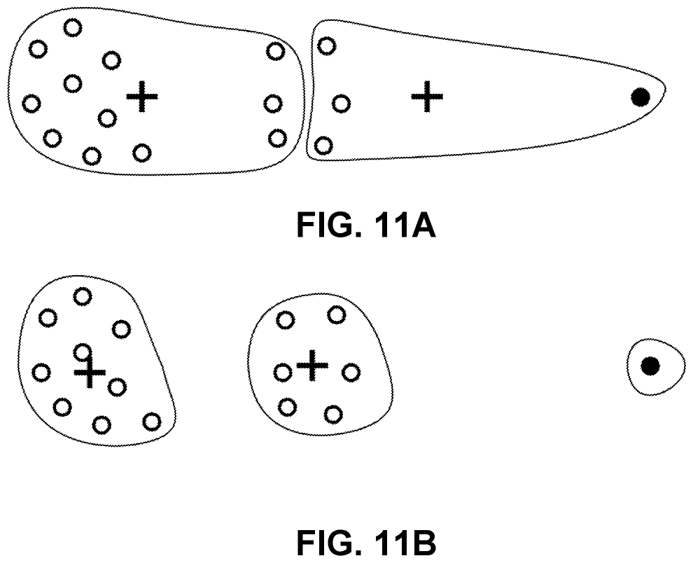

An outlier may be detected and may be removed, for example, as described herein. A K-means process (for example, an algorithm) may be used for vector quantization. In examples, a K-means process may assume (for example, operate based on) one or more of the following: the distribution of a variable may be spherical; one or more (for example, all) variables may have the same variance; and/or a prior probability of one or more (for example, all) k clusters may be the same. In examples, clusters may be produced based on one or more of the assumptions. In examples, cluster desirability or quality may be based on satisfaction of one or more of the assumptions. Cluster quality may be based on, for example, selection of the number of clusters, initialization of cluster centers, and/or characteristics of the data. FIGS. 11A and 11B illustrate an example K-means clustering without and with outlier removal. As shown in FIG. 11A, a k-means process may fail to find proper clusters, for example, due to the existence of an outlier that may violate or break one or more operational assumptions (for example, as described herein). As shown in FIG. 11B, a k-means process may find proper or correct dusters, for example, based on detection and separation or removal of an outlier (for example, the filled circle with a dashed boundary shown by example in FIG. 11B).

An outlier may be represented, for example, by a pair (w_{id}, id) indicating, for example, the outlier's attributes w_{id} and the outlier's index id in the original matrix. In examples with nₒ outliers, the outliers may be encoded (for example, encoded directly), for example, with a codebook of shape nₒ×dₜ and a list of an integer index with a range, for example, from 0 to n−1, which may represent the index of the outlier in the original weight matrix.

An outlier detection process may be selected, for example, based on the dimension of the points. In examples (for example, one-dimensional points, where dₜ=1), the mean μ and the standard deviation σ of a real number may be derived and used as a criterion for outlier detection. Outliers may be detected, for example, by examining the distance to the mean, for example, in accordance with Equation (3):

Outliers=(wᵢ∥wᵢ−μ|>λσ) (3)

The parameter λ may be a hyperparameter to set a threshold. FIGS. 12A and 12B illustrate an example of outlier detection, for example, for one dimensional points. For example, FIGS. 12A and 12B may provide an example of the statistics of a convolutional layer in a benchmarking neural network for image classification (for example, in NNR), such as ResNet50. FIG. 12A may show the intensity of the weights. FIG. 12B may show an outlier detection scheme, for example, based on Equation (3). An outlier detection process may be selected to find an outlier(s), for example, for high dimensional data. Examples of an outlier detection process may include Z-score and/or principal components analysis.

FIG. 13 illustrates an example of quantization with outlier removal. In examples, an input matrix may be a 20×10 matrix (for example, as shown in FIG. 13). Outlier detection may detect or identify, for example, five (5) outliers. The five outliers may be associated with one or more row indices, for example, row indices 0, 3, 9, 14, 18 in the 20×10 matrix. The outliers may be encoded with their original attributes and indices in the matrix. The outliers may be removed. As shown in FIG. 13,15 points (for example, inliers) may be clustered into 4 clusters (for example, cluster 0, cluster 1, cluster 2, and cluster 3), for example, after removing the outliers. Cluster centers may form a codebook of size 4×10. A list of 15 unsigned integers may be used, for example, to record the corresponding cluster index of the 15 inliers. The cluster index may range, for example, between [0, 3]. An (for example, each) index may be stored, for example, with 2 bits (for example, to represent a range between 0 and 3).

The codebook of the inliers and outliers may be combined. The codebook may be concatenated, for example, based on the two codebooks and code index lists in each group (for example, inliers and outliers) and the index of the outliers in the original tensor. The code index lists may be rearranged into a tensor of the shape similar to (for example, identical to) the original input weight tensor. Combining and/or rearranging the codebooks may reduce the storage memory. The outlier index in the original input weight tensor may have a dynamic range, which may utilize a large (for example, a larger) bit depth for storage. The outlier index in the original input weight tensor may be skipped (for example, removed), for example, after merging the codebooks.

A codebook may be sorted, for example, for scalar quantization. A codebook may be sorted, for example, with an ascending order for scalar quantization. The magnitude of a code index may be related to a magnitude of a corresponding value. A codebook may be compressed (for example, further compressed) with other compression techniques, such as compression techniques that may be used in video coding.

Coding methods (for example, encoding and decoding methods) may be provided for clustering-based quantization for NN compression and decompression. Coding methods may be implemented, for example, by a codec (coder/decoder).

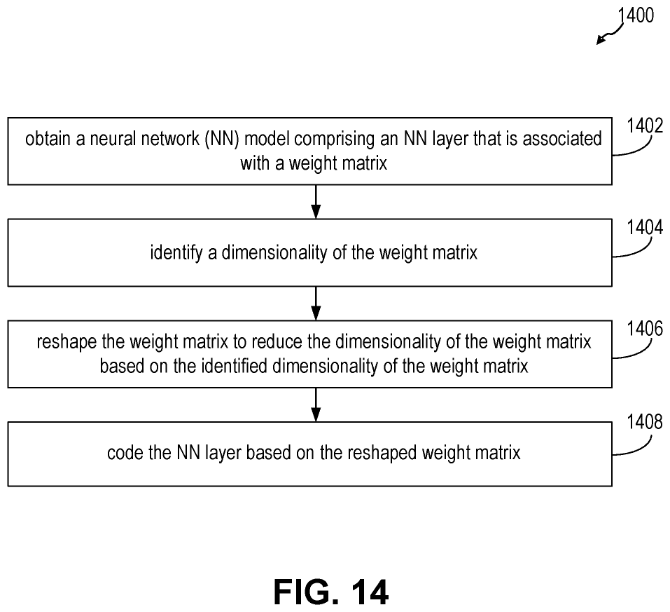

FIG. 14 illustrates an example of a method for encoding an NN network model. Examples disclosed herein and other examples may operate, in whole or in part, in accordance with example method 1400 shown in FIG. 14. Method 1400 may include one or more of 1402-1408. In 1402, an NN model may be obtained, for example, by a coding device, such as an encoder. The NN model may include an NN layer that is associated with a weight matrix. In 1404, a dimensionality of the weight matrix may be identified. In 1406, the weight matrix may be reshaped, for example, to reduce the dimensionality of the weight matrix based on the identified dimensionality of the weight matrix. In 1408, the NN layer may be coded based on the reshaped weight matrix. Encoding may be implemented, for example, by a coding device, such as an encoder shown in FIG. 2.

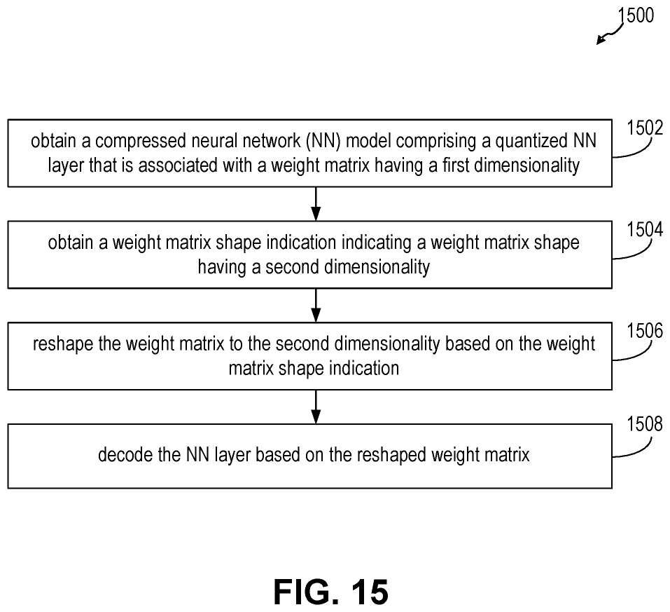

FIG. 15 illustrates an example of a method for decoding a compressed NN network model. Examples disclosed herein and other examples may operate, in whole or in part, in accordance with example method 1500 shown in FIG. 15. Method 1500 may include one or more of 1502-1508. In 1502, a compressed NN model may be obtained. The NN model may include a quantized NN layer that is associated with a weight matrix having a first dimensionality. In 1504, a weight matrix shape indication indicating a weight matrix shape having a second dimensionality may be obtained. In 1506, the weight matrix may be reshaped to the second dimensionality based on the weight matrix shape indication. In 1508, the NN layer may be decoded based on the reshaped weight matrix. Decoding may be implemented, for example, by a coding device, such as a decoder shown in FIG. 3.

Many examples are described herein. Features of examples may be provided alone or in any combination, across various claim categories and types. Further, examples may include one or more of the features, devices, or aspects described herein, alone or in any combination, across various claim categories and types, such as, for example, any of the following.

Methods may be implemented (for example, in a codec) to perform clustering-based quantization or inverse quantization for NN compression or decompression/reconstruction of a compressed NN. The methods may be implemented, for example, by an apparatus, which may include one or more processors configured to execute computer executable instructions, which may be stored on a computer readable medium or a computer program product, that, when executed by the one or more processors, performs the method. The apparatus may include one or more processors configured to perform the method. The computer readable medium or the computer program product may include instructions that cause one or more processors to perform the methods by executing the instructions. A computer readable medium may include data content generated according to the methods. A signal may include a codebook and code index, outliers and an outlier index and/or predictions for a weight matrix or a block of weights in a weight matrix generated based on clustering-based quantization with reshaping, outlier detection and removal and/or predictive coding for NN compression of an original weight matrix according to the methods described herein.

A method of encoding using clustering-based quantization for NN compression may include, for example, obtaining an NN model comprising an NN layer that is associated with a weight matrix, such as a weight tensor; identifying a dimensionality of the weight matrix; reshaping the weight matrix to reduce the dimensionality of the weight matrix based on the identified dimensionality of the weight matrix; and coding the NN layer based on the reshaped weight matrix. For example, the method may be implemented by an encoder, such as example encoder 200 shown in FIG. 2, operating in accordance with the method shown in FIG. 14. An encoder may implement the method shown in FIG. 14, for example, by operating in accordance with example operation, in whole or in part, as shown in FIGS. 7, 9, 10A-C, 11A-B and 13.

Reshaping the weight matrix may include, for example, flattening or rearranging the dimensionality of the weight matrix. For example, example encoder 200 may rearrange the matrix as shown by examples in FIG. 9 or FIGS. 10A-C.

A dimensionality of the weight matrix may include, for example, two dimensions (2D), three dimensions (3D), four dimensions (4D), or higher dimensions. The weight matrix may be reshaped, for example, to a one-dimension (1D) weight vector. Dimensionality may be reduced from a multi-dimension to (for example, any) lower dimension (for example, 4D to 3D, 4D to 2D, 3D to 2D, 2D to 1D, 3D to 1D, 4D to 1D, etc.) and/or other rearrangements, as shown by examples in FIG. 9 and FIGS. 10A-C.

An NN layer may include, for example, a convolutional NN (CNN) layer, a fully connected layer, or a bias layer.

A method may include, for example, transmitting the identified dimensionality and the reduced dimensionality of the weight matrix in a bitstream. For example, as shown in FIG. 7, arrangement metadata, codebook and code index may be coded (for example, by entropy coding 245 shown in FIG. 2) and transmitted in a bitstream (for example, to a decoder).

In an example, coding the NN layer may include performing quantization. Quantization may be clustering-based quantization. Outliers may be removed prior to quantizing inliers within a cluster. Quantization may include, for example, vector quantization. For example, example encoder 200 shown in FIG. 2 may operate in accordance with FIG. 7 to perform outlier detection, scalar quantization or vector quantization.

The method may further include performing prediction (for example, for a current block of weights or a current weight matrix) based on the reshaped or previously coded block of weights or weight matrix. For example, example encoder 200 shown in FIG. 2 may perform intra prediction 260 based on example operation shown in FIG. 7.

A method of decoding may include, for example, obtaining a compressed NN model comprising a quantized NN layer that is associated with a weight matrix having a first dimensionality; obtaining a weight matrix shape indication indicating a weight matrix shape having a second dimensionality; reshaping the weight matrix to the second dimensionality based on the weight matrix shape indication; and decoding the NN layer based on the reshaped weight matrix. For example, the method may be implemented by a decoder, such as example decoder 300 shown in FIG. 3, operating in accordance with the method shown in FIG. 15. A decoder may implement the method shown in FIG. 15, for example, by operating in accordance with example operation, in whole or in part, as shown in FIG. 8 and, for example, in reverse operation, in whole or in part, as shown in FIGS. 7, 9, 10A-C, and/or 13.

Reshaping the weight matrix may include, for example, restoring the weight matrix having the first dimensionality to the weight matrix having the second dimensionality. The weight matrix shape having the second dimensionality may include, for example, the weight matrix having an original dimensionality prior to the quantization. The weight matrix shape indication may include, for example, a number of columns and a number of rows associated with the original dimensionality. For example, example decoder 300 in FIG. 3 may operate in accordance with FIG. 8 to restore the original shape of a weight matrix/tensor, such as the original matrix/tensor shown in FIG. 9 and/or in FIG. 10A.

The second dimensionality of the weight matrix may include, for example, 2D, 3D, 4D, or higher dimensions. The weight matrix is reshaped, for example, by increasing the first dimensionality of the weight matrix to the second dimensionality of the weight matrix. Dimensionality may be increased from a lower dimension to a higher dimension (for example, 3D to 4D, 2D to 4D, 2D to 3D, 1D to 2D, 1D to 3D, 1D to 4D, etc.) and/or other arrangement reconstruction, as shown by examples in FIG. 9 and FIGS. 10A-C.

In examples, an encoder, such as a neural network (NN) model based video encoder, may be configured to obtain an NN model having multiple layers; identify, for a convolutional layer of the NN model, a convolutional layer weight tensor (for example, a 4-D tensor, such as K1×K2×Cin×Cout); rearrange the convolutional layer weight tensor, for example, by vectorizing the weight matrix in into a vector (for example, K1×K2→K1K2); and perform vector quantization on the convolutional layer using the rearranged convolutional layer weight tensor (for example, K1K2×Cin×Cout). For example, an encoder, such as example encoder 200 shown in FIG. 2, may be configured to perform the operations. A decoder, such as a NN model based video decoder (for example decoder 300 shown in FIG. 3), may be configured to perform the operations in reverse.

Each feature disclosed anywhere herein is described, and may be implemented, separately individually and in any combination with any other feature disclosed herein and/or with any feature(s) disclosed elsewhere that may be impliedly or expressly referenced herein or may otherwise fall within the scope of the subject matter disclosed herein.

Although features and elements are described above in particular combinations, one of ordinary skil in the art will appreciate that each feature or element may be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-14. (canceled)

15. A method of encoding comprising:
obtaining a neural network (NN) model, wherein the NN model comprises an NN layer, and wherein the NN layer is associated with a weight matrix;
identifying a dimensionality of the weight matrix;
based on the identified dimensionality of the weight matrix, reshaping the weight matrix to reduce the dimensionality of the weight matrix; and
coding the NN layer based on the reshaped weight matrix.

16. The method of claim 15, wherein reshaping the weight matrix comprises flattening or rearranging the dimensionality of the weight matrix.

17. The method of claim 15, wherein the dimensionality of the weight matrix comprises a two-dimension, a three-dimension, or a higher dimension, and the weight matrix is reshaped to a one-dimension weight vector.

18. The method of claim 15, wherein the method comprises at least one of:
transmitting the identified dimensionality and the reduced dimensionality of the weight matrix in a bitstream; or
performing prediction based on the reshaped weight matrix.

19. The method of claim 15, wherein coding the NN layer comprises performing a quantization on the NN layer, and wherein the quantization comprises vector quantization.

20. An apparatus for encoding comprising:
a processor configured to:
obtain a neural network (NN) model, wherein the NN model comprises an NN layer, and wherein the NN layer is associated with a weight matrix;
identify a dimensionality of the weight matrix;
based on the identified dimensionality of the weight matrix, reshape the weight matrix to reduce the dimensionality of the weight matrix; and
coding the NN layer based on the reshaped weight matrix.

21. The apparatus of claim 20, wherein to reshape the weight matrix comprises being configured to flatten or rearrange the dimensionality of the weight matrix.

22. The apparatus of claim 20, wherein the dimensionality of the weight matrix comprises a two-dimension, a three-dimension, or a higher dimension, and the weight matrix is reshaped to a one-dimension weight vector.

23. The apparatus of claim 20, wherein the processor is configured to:
transmit the identified dimensionality and the reduced dimensionality of the weight matrix in a bitstream.

24. The apparatus of claim 20, wherein coding the NN layer comprises performing a quantization on the NN layer, and wherein, the quantization comprises a vector quantization.

25. The apparatus of claim 20, the processor is configured to:
perform prediction based on the reshaped weight matrix.

26. A method of decoding comprising:
obtaining a compressed neural network (NN) model, wherein the compressed NN model comprises a quantized NN layer, and wherein the quantized NN layer is associated with a weight matrix having a first dimensionality;
obtaining a weight matrix shape indication, wherein the weight matrix shape indication indicates a weight matrix shape having a second dimensionality;
based on the weight matrix shape indication, reshaping the weight matrix to the second dimensionality; and
decoding the NN layer based on the reshaped weight matrix.

27. The method of claim 26, wherein reshaping the weight matrix comprises restoring the weight matrix having the first dimensionality to the weight matrix having the second dimensionality.

28. The method of claim 26, wherein the weight matrix shape having the second dimensionality comprises the weight matrix having an original dimensionality prior to the quantization, and wherein the weight matrix shape indication comprises a number of columns and a number of rows associated with the original dimensionality.

29. The method of claim 26, wherein the second dimensionality of the weight matrix comprises a two-dimension, a three-dimension, or a higher dimension, and the weight matrix is reshaped by increasing the first dimensionality of the weight matrix to the second dimensionality of the weight matrix.

30. An apparatus for decoding comprising:
a processor configured to:
obtain a compressed neural network (NN) model, wherein the compressed NN model comprises a quantized NN layer, and wherein the quantized NN layer is associated with a weight matrix having a first dimensionality;
obtain a weight matrix shape indication, wherein the weight matrix shape indication indicates a weight matrix shape having a second dimensionality;
based on the weight matrix shape indication, reshape the weight matrix to the second dimensionality; and
decode the NN layer based on the reshaped weight matrix.

31. The apparatus of claim 30, wherein to reshape the weight matrix comprises being configured to restore the weight matrix having the first dimensionality to the weight matrix having the second dimensionality.

32. The apparatus of claim 30, wherein the weight matrix shape having the second dimensionality comprises the weight matrix having an original dimensionality prior to the quantization, and wherein the weight matrix shape indication comprises a number of columns and a number of rows associated with the original dimensionality.

33. The apparatus of claim 30, wherein the second dimensionality of the weight matrix comprises a two-dimension, a three-dimension, or a higher dimension, and the weight matrix is reshaped by increasing the first dimensionality of the weight matrix to the second dimensionality of the weight matrix.
